(19) United States
(12) Patent Application Publication
(10) Pub. No.: US 2007/0133804 A1
(43) Pub. Date: Jun. 14, 2007

(54) Techniques to scramble wireless communications

(75) Inventor: Assaf Kasher, Haifa (IL)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/302,051

(22) Filed: Dec. 12, 2005

(51) Int. Cl. H04K 1/00; H04H 1/00

(52) U.S. Cl. 380/270; 380/274; 455/3.01; 370/913

(57) ABSTRACT

An embodiment of the present invention provides a method, comprising scrambling data prior to transmission by a transmitter, wherein the scrambling is capable of being either random or by use of one of a plurality of scrambler seeds.

### BACKGROUND

Wireless communications, including wireless networks, have become pervasive throughout society. Improvements in wireless communications are vital to increase their reliability and speed. In many communication protocols, the data is scrambled before being transmitted. This is done to make the data at the transmitter relatively random and to prevent long sequences of ones or zeros that frequently occur at the input data from being modulated. Without the scrambler, a receiver may loose synchronization or in the case of orthogonal frequency division multiplexing (OFDM) transmission, packets with very large peak to average will occur frequently and induce clipping in the digital to analog converter (DAC) and analog to digital converter (ADC).

Thus, a strong need exists for improved techniques to scramble wireless communications.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an 802.11n suggested packet structure of an embodiment of the present invention; and

FIG. 2 shows a comparison of scrambler initialization methods of some embodiments of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN) and Mesh networks.

Although the present invention is not limited to any particular wireless communication standard, the 802.11 standard defines a scrambler that is based on performing an xor operation between the input and a pseudo random sequence. The pseudo random sequence may be 127 bits long and may be repeated if the input sequence is longer—although it is understood that the present invention is not limited in this respect. The starting point in the sequence may also be random—this is important since if xoring the input sequence with one scrambling sequence still created a high peak in the transmitted sequence, xoring it with another sequence once it is retransmitted, may solve the problem. The receiver is capable of detecting the starting point in the sequence, since the first 7 bits transmitted are zero.

Although not limited in this respect, in the TGn Sync proposal for the 802.11n standard, this approach is changed. Instead of a random scrambler initialization, one of four known scrambler seeds which define the point in the sequence may be used. The index of the scrambler seed may be transmitted in the high throughput signal field which may be transmitted using robust modulation, preceding the data. The reason for this is that the scrambler initialization bits need special protection since an error in one of them will destroy the whole aggregate packet, while an error in other bits will destroy one MPDU out of many in the packet. Other 802.11n standards submissions do not prefer this method since it is not random enough.

An embodiment of the present invention provides a technique that may work well both in A-MPDU aggregation and in non aggregated packets. In an embodiment of the present invention, there may be two bits in the high throughput (HT) signal field specifying one of three scramblers if the value of these two bits is b'01, b'10, b'11. If these two bits are b'00, the value of the scrambler is random. In an embodiment of the present invention, the scrambler initialization bits will be in the first seven bits (set to zero before scrambling), of the data portion of the packet, although the present invention is not limited to the first seven bits.

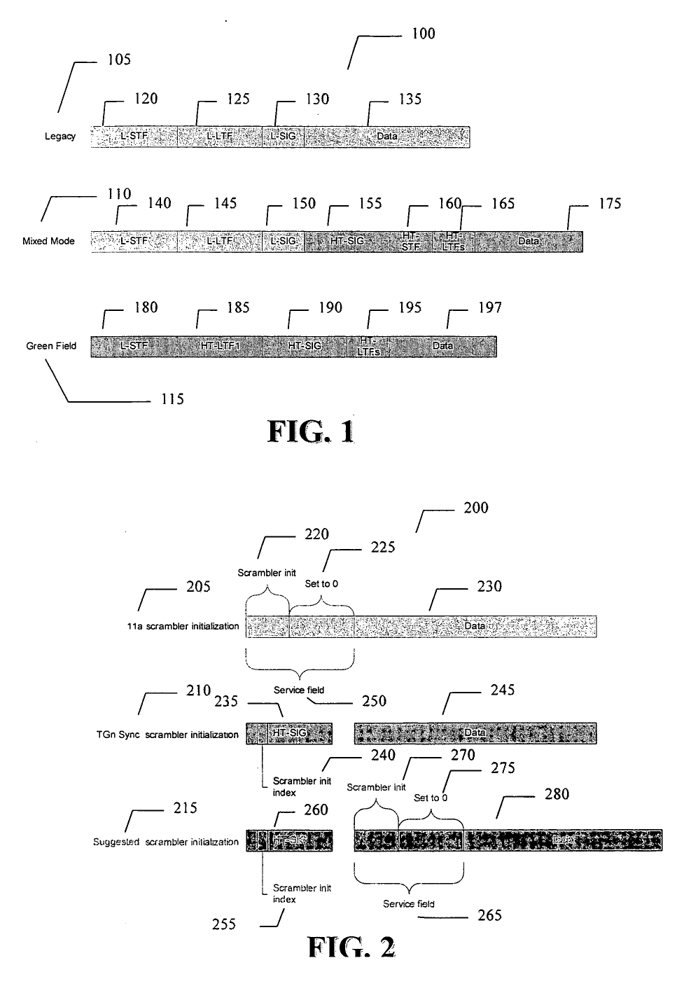

Turning now to the figures, FIG. 1, generally at 100, illustrates an 802.11n suggested packet structure of an embodiment of the present invention. Legacy structure 105 may comprise legacy-short training field (L-STF) 120 followed by legacy long training field (L-LTF) 125, legacy signal field 130 and data 135. Mixed mode structure 110 may comprise legacy-short training field (L-STF) 140 followed by legacy long training field (L-LTF) 145, legacy signal field 150, high throughput signal field (HT SIG) 155, high throughput short training field (HT-STF) 160, high throughput long training field (HT-LTF) 165, and data 175. The green field structure is shown at 115 and may comprise legacy short training field (L-STF) 180, high throughput long training field one (HT-LTF1) 185, high throughput signal field 190, high throughput long training field (LTFs) 195 and data 197.

FIG. 2 shows generally at 200 a comparison of scrambler initialization methods of some embodiments of the present invention. 205 provides an 802.11a scrambler with scrambler initiation 220 set to 0 225 both in service field 250 followed by data 230. TGn Sync scrambler initiation is depicted at 210 with scrambler init index 240 and HT-SIG 235 prior to data 245. An embodiment of the present invention provides a novel scrambler 215 which may comprise scrambler init index 255 and HT-SIG 260 preceding service field 265 which may include scrambler init 270 and set to 0 270 preceding data 280.

An embodiment of the present invention may further provide a method, comprising scrambling data prior to transmission by a transmitter, wherein the scrambling is capable of being either random or by use of one of a plurality of scrambler seeds. The plurality of scrambler seeds may be four scrambler seeds and the present method may further comprise transmitting an index of the four scrambler seeds in a high throughput signal field which may be transmitted using robust modulation preceding data. In an embodiment of the present method, indicating the scrambling technique may be by a plurality of bits in an HT signal field specifying one of a plurality of scramblers; further, the plurality of bits may be two and the plurality of scramblers may be three and if the value of the two bits is b'01, b'10, b'11 scrambler seeds are indicated and if the two bits are b'00, the value of the scrambler is random. The present method may provide setting to zero scrambler initialization bits before scrambling and placing the scrambler initialization bits in the first seven bits of a data portion of a packet. The present method may further comprise operating the transmitter in a wireless local area network according to an 802.11n standard and may also further comprise operating the transmitter using A-MPDU aggregation or non aggregated packets.

Another embodiment of the present invention provides instructions, which when accessed, cause a machine to perform operations comprising scrambling data prior to transmission by a transmitter, wherein the scrambling is capable of being either random or by use of one of a plurality of scrambler seeds.

Still another embodiment of the present invention provides a system, comprising a transmitter capable of scrambling data prior to transmission, wherein the scrambling is capable of being either random or by use of one of a plurality of scrambler seeds and a receiver in communication with the transmitter and capable of receiving the scrambled data. An embodiment of the present system also provides an antenna associated with the transmitter and an antenna associated with the receiver to facilitate communication between the transmitter and the receiver.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a transmitter capable of scrambling data prior to transmission, wherein said scrambling is capable of being either random or by use of one of a plurality of scrambler seeds.

2. The apparatus of claim 1, wherein said plurality of scrambler seeds is four scrambler seeds.

3. The apparatus of claim 2, wherein an index of said four scrambler seed is transmitted in a high throughput signal field which is transmitted using robust modulation preceding data.

4. The apparatus of claim 1, wherein the scrambling technique is indicated by a plurality of bits in an HT signal field specifying one of a plurality of scramblers.

5. The apparatus of claim 4, wherein said plurality of bits is two and said plurality of scramblers is three and if the value of said two bits is b'01, b'10, b'11 scrambler seeds are indicated and if said two bits are b'00, the value of said scrambler is random.

6. The apparatus of claim 5, wherein the scrambler initialization bits are in the first seven bits of the data portion of a packet and are set to zero before scrambling,

7. The apparatus of claim 1, wherein said transmitter is operable in communicating in a wireless local area network according to the 802.11n standard.

8. The apparatus of claim 7, wherein said transmitter is operable in communicating in a wireless local area network using A-MPDU aggregation and in non aggregated packets.

9. A method, comprising:
scrambling data prior to transmission by a transmitter, wherein said scrambling is capable of being either random or by use of one of a plurality of scrambler seeds.

10. The method of claim 9, wherein said plurality of scrambler seeds is four scrambler seeds.

11. The method of claim 10, further comprising transmitting an index of said four scrambler seeds in a high throughput signal field which is transmitted using robust modulation preceding data.

12. The method of claim 9, further comprising indicating the scrambling technique by a plurality of bits in an HT signal field specifying one of a plurality of scramblers.

13. The method of claim 12, wherein said plurality of bits is two and said plurality of scramblers is three and if the value of said two bits is b'01, b'10, b'11 scrambler seeds are indicated and if said two bits are b'00, the value of said scrambler is random.

14. The method of claim 13, further comprising setting to zero scrambler initialization bits before scrambling and placing said scrambler initialization bits in the first seven bits of a data portion of a packet,

15. The method of claim 9, further comprising operating said transmitter a wireless local area network according to 802.11n standard adopted.

16. The apparatus of claim 15, further comprising operating said transmitter a wireless local area network using A-MPDU aggregation and in non aggregated packets.

17. A machine-accessible medium that provides instructions, which when accessed, cause a machine to perform operations comprising:
scrambling data prior to transmission by a transmitter, wherein said scrambling is capable of being either random or by use of one of a plurality of scrambler seeds.

18. The machine-accessible medium of claim 17, wherein said plurality of scrambler seeds is four scrambler seeds.

19. The machine-accessible medium of claim 18, further comprising said instructions causing said machine to perform operations further comprising transmitting an index of said four scrambler seeds in a high throughput signal field which is transmitted using robust modulation preceding data.

20. The machine-accessible medium of claim 17, further comprising said instructions causing said machine to perform operations further comprising indicating the scrambling technique by a plurality of bits in an HT signal field specifying one of a plurality of scramblers.

21. The machine-accessible medium of claim 20, wherein said plurality of bits is two and said plurality of scramblers is three and if the value of said two bits is b'01, b'10, b'11 scrambler seeds are indicated and if said two bits are b'00, the value of said scrambler is random.

22. The machine-accessible medium of claim 21, further comprising said instructions causing said machine to perform operations further comprising setting to zero scrambler initialization bits before scrambling and placing said scrambler initialization bits in the first seven bits of a data portion of a packet,

23. The machine-accessible medium of claim 17, further comprising said instructions causing said machine to perform operations further comprising operating said transmitter a wireless local area network according to 802.11n standard adopted.

24. The machine-accessible medium of claim 23, further comprising said instructions causing said machine to perform operations further comprising operating said transmitter a wireless local area network using A-MPDU aggregation and in non aggregated packets.

25. A system, comprising:
a transmitter capable of scrambling data prior to transmission, wherein said scrambling is capable of being either random or by use of one of a plurality of scrambler seeds; and
a receiver in communication with said transmitter and capable of receiving said scrambled data.

26. The system of claim 25, further comprising an antenna associated with said transmitter and an antenna associated with said receiver to facilitate communication between said transmitter and said receiver.

27. The system of claim 25, wherein the scrambling technique is indicated by a plurality of bits in an HT signal field specifying one of a plurality of scramblers.

28. The system of claim 27, wherein said plurality of bits is two and said plurality of scramblers is three and if the value of said two bits is b'01, b'10, b'11 scrambler seeds are indicated and if said two bits are b'00, the value of said scrambler is random.
